(19) United States
(12) Patent Application Publication
(10) Pub. No.: US 2025/0233354 A1
(43) Pub. Date: Jul. 17, 2025

(54) CORROSION-RESISTANT PLUG CONNECTOR HOUSING

(71) Applicant: HARTING ELECTRIC STIFTUNG & CO. KG, Espelkamp (DE)

(72) Inventors: Marc SCHLETH, Lemförde (DE); Martin SCHMIDT, Lübbecke (DE); Daniel WESSELER, Georgsmarienhütte (DE)

(21) Appl. No.: 18/702,732

(22) PCT Filed: Oct. 24, 2022
(86) PCT No.: PCT/DE2022/100785

§ 371 Date: Apr. 18, 2024

(30) Foreign Application Priority Data
Nov. 3, 2021 (DE) 10 2021 128 635.2

(51) Int. Cl. H01R 13/533

(52) U.S. Cl. CPC H01R 13/533

(57) ABSTRACT

A plug connector housing is provided having at least two oppositely arranged locking pins protruding from the outside, wherein each locking pin includes a metallic component which is overmolded at least in some regions with a plastic material.

### BACKGROUND

### Technical Field

Embodiments of the present disclosure relate to a plug connector housing and a plug connector in which such a plug connector housing is used.

Such plug connector housings are also referred to as grommet, socket or coupling housings, and may be composed of aluminum or an aluminum alloy, such as when used in harsh industrial environments.

### Description of the Related Art

The document DE 20 2011 105 009 Ul shows a plug connector that can be assembled on an apparatus wall. Plug connectors of this type are also referred to as industrial plug connectors.

The plug connector housing shown here has locking pins on which a U-shaped locking bracket can be pivotably mounted. Alternatively, the locking pins can also be used to engage across such a locking bracket. Such a plug connector is able to be plugged to a mating plug connector. Plug connectors and mating plug connectors can be locked to one another via the locking bracket. In this instance, the locking bracket of the plug connector, in the locked state, engages across the locking pins disposed on the mating plug connector housing. As a result, the plug connectors, or their plug connector housings, are firmly pressed against one other, respectively.

Often, so-called riveting bolts are used as locking pins, wherein the plug connector housing and the riveting bolts are made of different materials. The plug connector housing is typically composed of a die-cast aluminum material, while the riveting bolt is typically composed of steel for stability reasons. Due to this material selection, undesirable contact corrosion occurs on the contact regions between the plug connector housing and the locking pins, or riveting bolts, respectively. This contact corrosion is particularly facilitated in harsh industrial environments.

The issue of contact corrosion is chemically tackled in the document EP 3 105 370 A1. EP 3 105 370 A1 shows a plug connector housing and/or an attachment housing with riveting bolts or locking pins mentioned above. The riveting bolts are provided with a metallic layer that reduces the contact corrosion between the housing material and the base material of the riveting bolts. Chemical processes of this type are complex and therefore render the plug connector housing more expensive. It has also been found that the chemical surface of the riveting bolts wears out over time due to mechanical stress during the locking procedure, and contact corrosion still occurs after a certain period of time.

The document DE 10 2019 108 628 A1 shows a plug connector housing in which a metallic plug connector housing and a metallic locking pin are galvanically separated from one other by a spacer, in order to prevent contact corrosion. The spacer is shaped as a sleeve-shaped component and must be provided separately in the production process, which increases the manufacturing costs. Moreover, the spacer is abraded over time, ultimately leading to the onset of contact corrosion.

A search by the German Patent and Trade Mark Office has found the following prior art in the priority application for the present application:
DE 10 2016 114 808 A1, DE 10 2019 108 628 A1 and DE 18 37 972 U.

### BRIEF SUMMARY

Embodiments of the disclosure provide a reliable, cost-effective and durable plug connector housing.

The plug connector housing described herein has, on the outside, at least two protruding locking pins which are disposed so as to be mutually opposite. A locking bracket is able to be pivotably mounted on the locking pins. The locking pins can likewise also be encompassed by such a locking bracket, in order to lock the plug connection. Depending on the situation, either a plug connector, for example equipped with an attachment housing which is screwed to a machine, or a mating plug connector, for example equipped with a grommet housing, can be equipped with the necessary locking bracket as a result.

In some embodiments, the plug connector housing may have a substantially rectangular cross section. Plug connectors embodied in this manner are also referred to as rectangular plug connectors or industrial plug connectors. In this instance, the long sides of the plug connector housing can then in each case be equipped with two locking pins. In such a case, the plug connector housing would have a total of four locking pins. Such a plug connector housing could therefore also be equipped with two locking brackets which are mounted on mutually opposite locking pins of the long sides and are pivotable over the narrow sides of the plug connector housing.

In some embodiments, the respective locking pin may be composed substantially of a metallic component which is at least in regions overmolded with a plastics material. As a result, the materials of the plug connector housing and of the locking pins can be freely selected. The contact corrosion is already mitigated by the plastics material overmolding which allows less air and other corrosive media to reach the contact region between the metallic component of the locking pin and the plug connector housing.

In other words, the locking pin has a metallic core, which at least in regions is encased by a non-metallic material.

In some embodiments, the metallic component may be a riveting bolt or threaded bolt. The respective locking pin therefore has a riveting bolt or threaded bolt. For example, the plug connector housing is composed of aluminum or an aluminum alloy. The choice of material for the locking pin can be determined by selecting suitable riveting bolts or threaded bolts. Here, for example, riveting bolts or threaded bolts made of steel are used, which are durable and reliable. Advantageously, however, the riveting bolt or threaded bolt may be composed of aluminum or an aluminum alloy. With a corresponding die-cast aluminum housing, no, or hardly any, contact corrosion would occur as a result since the materials of the plug connector housing and of the riveting bolt or threaded bolt are electrochemically closely adjacent.

In some embodiments, the riveting bolt or threaded bolt may have two encircling and mutually spaced-apart webs.

Advantageously, one web is disposed on a wall of the plug connector housing and is supported thereon. The other web is then provided on the end side on the riveting bolt or threaded bolt. Such a geometry has proved to be mechanically stable.

Advantageously, the plastics material may be disposed between the webs. The locking bracket engages across the locking pins in this region. The surface of the plastics material enables low friction and thus a user-friendly locking procedure here.

In some embodiments, the webs are also at least in regions overmolded by the plastics material. That web that is disposed directly on the plug connector housing is in direct physical contact with the plug connector housing wall, but the region situated around it is coated with the plastics material. This prevents ingress of moisture and especially also air, so that corrosion, such as contact corrosion, is effectively reduced.

The web disposed on the end side ensures a stable footing of the plastics material on the riveting bolt or threaded bolt, and is also important for mechanical stability of the locking pin. In some embodiments, the locking pin may be designed to be substantially cylindrical. In this way, the geometry overall does not differ from the known locking pins and can be used as usual.

### BRIEF DESCRIPTION OF THE SEVERAL VIEWS OF THE DRAWINGS

Embodiments of the disclosure are illustrated in the drawings and will be explained in more detail hereunder. FIG. 1 shows a perspective illustration of a plug connection.

FIG. 2 shows a perspective illustration of a riveting bolt or threaded bolt of a locking pin.

FIG. 3 shows a perspective illustration of an alternative riveting bolt or threaded bolt of a locking pin.

FIG. 4 shows a perspective illustration of the locking pin of a plug connector housing.

FIG. 5 shows a perspective illustration of the alternative locking pin of a plug connector housing.

### DETAILED DESCRIPTION

Some of the Figures contain simplified schematic illustrations. To some extent, identical reference signs are used for elements that are similar but might not be identical. Different views of the same elements may be drawn to different scales. Directional indications such as, for example, “left”, “right”, “top” and “bottom” are to be understood with reference to the respective figure and may vary in the individual illustrations relative to the displayed object.

FIG. 1 shows a perspective illustration of a plug connection SV composed of a first plug connector having a first plug connector housing 1 designed as a grommet housing, and a second plug connector having a second plug connector housing 1′ designed as an attachment housing.

Disposed in the plug connector housings 1, 1′ are in each case contact inserts with contact elements which ultimately ensure electrical contact of the plug connection. Since these components are not covered by the present inventive concept, the illustration of these components is dispensed with for reasons of clarity.

The second plug connector housing 1′ is equipped with a u-shaped locking bracket 2 which is pivotably mounted on mutually opposite locking pins 3′ of the second plug connector housing 1′ along the narrow sides.

The locking bracket 2 has bearing receptacles by way of which said locking bracket engages across the locking pins 3, associated therewith, of the first plug connector housing 1. As a result, the plug connector housings 1, 1′ are pressed against one another so that a reliable plug connection SV which is protected against ingress of media is created. Illustrated in FIG. 1 is a plug connection SV that has not yet been locked.

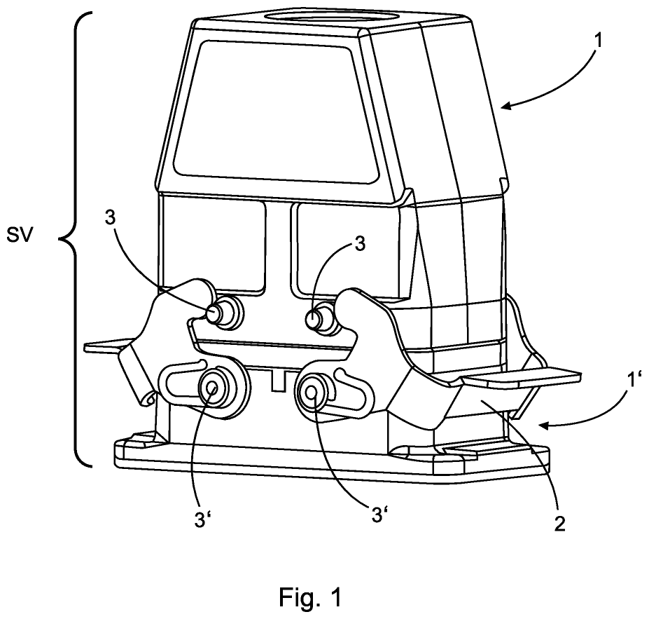

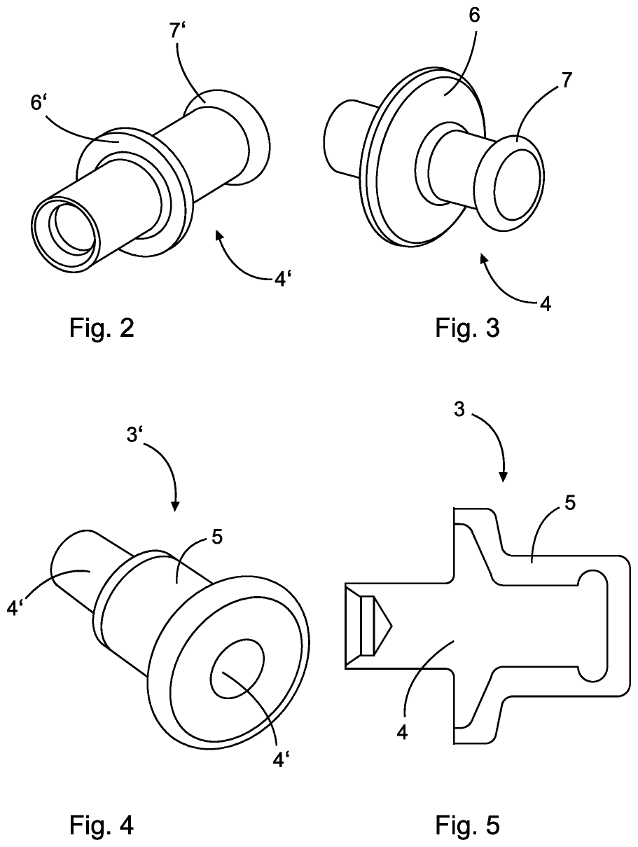

Illustrated in FIG. 4 is a locking pin 3′, which is provided for mounting a locking bracket 2. The locking pin 3′ shown here is composed of a riveting bolt or threaded bolt 4′, which is shown in a perspective view in FIG. 2.

The riveting bolt or threaded bolt 4′ substantially has a cylindrical design. A first encircling web 6′ is provided approximately in the center, and a second encircling web 7′ is provided on the end side. The riveting bolt or threaded bolt 4′ is supported on the plug connector housing 1′ via the first web 6′. The second web 7′ here supports the fixing of the locking bracket 2.

The riveting bolt or threaded bolt 4′ serves as a metallic core, or as a metallic component, which is overmolded by a plastics material 5. In this embodiment, aluminum, which is electrochemically very closely adjacent to the plug connector housing material, is chosen as the material for the riveting bolt or threaded bolt 4′. Therefore, no contact corrosion occurs in the contact region of the plug connector housing and the riveting bolt or threaded bolt 4′. The plastics material 5 serves to reinforce the riveting bolt or threaded bolt 4′ in order that the mechanical requirements are met.

Illustrated in FIG. 5 is a locking pin 3, which serves as a bearing receptacle for a locking bracket 2. The locking pin 3 shown here is composed of a riveting bolt or threaded bolt 4, which is shown in a perspective view in FIG. 3.

The riveting bolt or threaded bolt 4 has a cylindrical design. A first circumferential web 6 is provided approximately in the center, and a second circumferential web 7 is provided on the end side. The riveting bolt or threaded bolt 4 is supported on the plug connector housing 1 via the first web 6. The second web 7 guides the locking bracket 2 when the bearing receptacle of the latter slides onto the locking pin 3.

The riveting bolt or threaded bolt 4 functions as a metallic core, or as a metallic component, which is overmolded by a plastics material 5. In this embodiment, aluminum, which is electrochemically very closely adjacent to the plug connector housing material, is chosen as the material for the riveting bolt or threaded bolt 4. Therefore, contact corrosion does not occur in the contact region of the plug connector housing and the riveting bolt or threaded bolt 4. The plastics material 5 serves to reinforce the riveting bolt or threaded bolt 4′ in order that the mechanical requirements are met.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A plug connector housing, comprising:
at least two locking pins which project on an outside of the plug connector housing and are disposed so as to be mutually opposite, each locking pin being composed substantially of a metallic component that is overmolded with a plastics material at least in regions of the locking pin.

2. The plug connector housing as claimed in claim 1, wherein the metallic component is composed of aluminum or an aluminum alloy.

3. The plug connector housing as claimed in claim 1, wherein the plug connector housing is composed of aluminum or an aluminum alloy.

4. The plug connector housing as claimed in claim 1, wherein the metallic component of each locking pin has two encircling and mutually spaced-apart webs.

5. The plug connector housing as claimed in claim 4, wherein one web is supported on a wall of the plug connector housing, and the other web is provided on an end side on a riveting bolt or threaded bolt.

6. The plug connector housing as claimed in claim 5, wherein the plastics material is disposed substantially between the webs.

7. The plug connector housing as claimed in claim 6, wherein at least one web is overmolded by the plastics material at least in regions of the web.

8. The plug connector housing as claimed in claim 1, wherein each locking pin is designed to be substantially cylindrical.

9. The plug connector housing as claimed in claim 1, wherein the metallic component is embodied as a riveting bolt or threaded bolt.

10. A plug connector, comprising: a plug connector housing as claimed in claim 1.
